(19) United States
(12) Patent Application Publication
(10) Pub. No.: US 2003/0091169 A1
(43) Pub. Date: May 15, 2003

(54) System and method for providing telecommunications services

(76) Inventor: James B. Cain, Vero Beach, FL (US)

Correspondence Address: Larry G. Brown, Esq., Akerman, Senterfitt & Eidson, P.A., 222 Lakeview Avenue, 4th Floor, P.O. Box 3188, West Palm Beach, FL, 33402-3188, US

(21) Appl. No.: 10/010,823

(22) Filed: Nov. 13, 2001

(51) Int. Cl. H04M 11/00; H04M 1/64; H04M 15/00

(52) U.S. Cl. 379/114.2; 379/114.01; 379/114.16; 379/114.17; 379/88.18; 379/88.25; 379/88.26

(57) ABSTRACT

A method for providing telecommunication services includes the step of establishing a prepaid telephone account for a subscriber and providing an access telephone number. Access telephone information is received from a caller to the access telephone number. The access information is validated, the sufficiency of funds is determined, and the caller is permitted to access at least one premium telephone service. The prepaid account is debited for the access. A system for providing telecommunication services is also disclosed.

### BACKGROUND OF THE INVENTION

1. Field of the Invention

This invention relates generally to telecommunication services, and more particularly to the provision of premium telecommunication services such as voice mail messaging, conference calling, group messaging, and call forwarding.

2. Background of the Invention

Premium services have become popular with consumers of telecommunication services. Premium services can be generally defined as those services provided to consumers in addition to standard direct dial telephone calling. Such services include, but are not limited to, voice mail messaging, conference calling, group messaging, and call forwarding.

Prepaid telephone services such as those provided by calling cards purchased from retailers and other sources have become a common source for the purchase of direct dial telephone services. The calling cards typically bear an access telephone number and a password or identification number. Upon the purchase of the card, the consumer places direct dial telephone calls by first dialing the access number, entering the desired telephone number, and the password or identification number. The identification number is validated and the customer is connected to the desired telephone number. The customer's account is typically debited based upon the duration of the call, and possibly with an additional connect charge or other miscellaneous charges. The calling card is typically purchased for an amount of money that reflects the duration of the calls which will be authorized by the account designated by the password or identification number. Typical durations are in increments of minutes, such as fifty minutes, one hundred minutes, and the like. Upon exhaustion of the minutes afforded by the card, the account is terminated and the consumer must purchase another card bearing a new account number. The consumer accordingly must reestablish accounts on a repetitive basis. Also, calling cards do not afford consumers with access to premium telephone services.

### SUMMARY OF THE INVENTION

A method for providing telecommunications services includes the steps of establishing a prepaid telephone account for a subscriber and providing an access telephone number. Access information is received from a caller to the access telephone number. The access information is validated, and the sufficiency of funds for a requested service is determined. At least one premium telephone service is then performed. The caller can be the subscriber or a third party attempting to communicate with the subscriber. The prepaid telephone account is debited for the access.

The premium telephone service can be any suitable service in addition to direct telephone connections. Examples of premium telephone services for use in the invention include voice mail messaging, conference calling, group messaging, and call forwarding.

The premium service can be voice mail messaging. A voice mail messaging telephone number can be provided for callers to the subscriber to leave voice mail messages for the subscriber. The subscriber, upon validation of the access Information, is permitted to access these voice mail messages. A mailbox number can be provided for each subscriber, and callers can be prompted for the mailbox number prior to connecting the caller to the voice mailbox identified by the mailbox number. The telephone account can be debited pursuant to the connect time of either or both of the callers leaving voice messages in the voice mailbox, or the subscriber retrieving the messages. The same mailbox number is retained for the subscriber so long as the account is maintained at a pre-determined credit balance.

The step of establishing a prepaid telephone account can be accomplished by the purchase of a card by the subscriber. The card bears indicia for establishing the account. The indicia can include an identification number, a letter string, an alphanumeric string, or a password. The method can further include the step of receiving the indicia from the subscriber, and upon validation of the indicia, establishing the account. The indicia can identify a credit amount, and the method can further include the step of crediting the account according to the credit amount upon receipt and validation of the indicia. The indicia can be hidden from view on the card by removable masking. The subscriber upon purchasing the card removes the masking to view the indicia.

The method can include the step of crediting the account upon receipt of indicia signifying the purchase of credit by or for the subscriber. The credit indicia can be provided by any suitable method, such as providing the credit indicia on a card or other item that is purchased by the subscriber. The subscriber calls the access number, provides the credit indicia as by pressing telephone keys to key-in the indicia, and the indicia is referenced against a database that matches the indicia to a credit amount that is then credited to the account of the subscriber. Alternatively, the credit information can be purchased by the subscriber directly, as by calling a customer service representative and providing a valid credit card number to purchase credit for the account.

The account is debited according to the service that is provided to the subscriber. In the case of direct dialing and voice mail messaging, the debiting can be based upon the connect time to the called party or to the voice mailbox. In the case of conference calling, the debiting can be based on the connect time, but additional charges can be made for the conference calling feature. In the case of group messaging and call forwarding, the debiting can be performed based on connect time and/or by an appropriate surcharge. Any suitable method and rate structure for debiting the account of the subscriber according to the type and quantity or duration of premium service that is provided can be utilized.

The telephone numbers of callers to the voice mailbox can be identified by suitable caller identification techniques and equipment, and these numbers can be stored. The subscriber can be provided with a feature whereby, upon listening to the voice mail message, the subscriber can dial the caller to return the call without exiting the system. The subscriber account would be debited for both access to the voice mailbox and for the duration of the returned call, together with any appropriate surcharge. In one aspect, the return call can be made upon the selection of the subscriber without the need for the subscriber to re-enter the caller's telephone number.

A customer service center can be provided for performing various functions for the subscriber. These functions can include establishing an account, establishing a mailbox number, and receiving requests for and providing premium services such as group messaging, call forwarding and conference calling. The customer service center can be run automatically or with customer service representatives. The customer service center can be accessed through the access number, or a separate customer service telephone number can be provided. Callers for voice mail messaging can call the access number, or a separate voice mail messaging telephone number can be provided for callers who wish to leave voice mail messages for subscribers.

A system for providing premium telephone services includes a data processing system for establishing and maintaining prepaid subscriber accounts. A premium telephone service system provides premium telephone services for subscribers. The data processing system debits the prepaid subscriber account responsive to the provision of premium telephone services to the subscriber.

Cards can be provided for purchase by subscribers. The cards bear indicia for establishing an account, or for providing credit to the account. The credit indicated by the card is related to the purchase price of the card. The card can bear indicia identifying the amount of the credit, and this indicia can be supplied to the data processing system which then credits the account by the amount indicated by the indicia.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a system according to the invention.

FIG. 2 is a flow chart illustrating a method according to the invention.

### DETAILED DESCRIPTION OF THE PREFERRED EMBODIMENTS

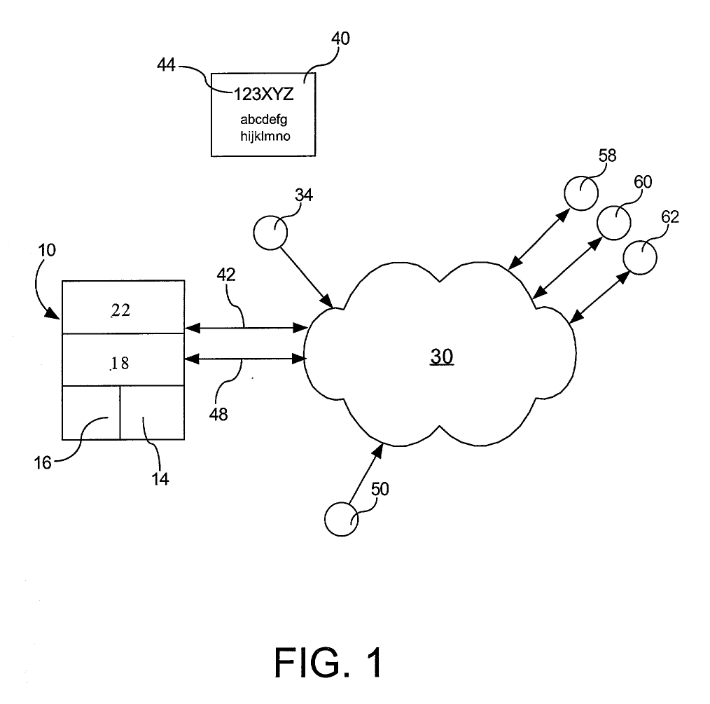

There is shown in FIG. 1 a system 10 according to the invention for providing telecommunication services, particularly premium telecommunication services. The premium telecommunication services can be any services in addition to direct dialing telecommunication services, including, but not limited to, voice mail messaging, conference calling, group messaging, and call forwarding. The system 10 includes a data processing system 14. The data processing system 14 maintains the prepaid telephone accounts for subscribers, debits the accounts for services that are performed, and credits the accounts when the subscriber has purchased additional credits. The data processing system 14 can include access to a suitable memory storage system 16 for storing credit information and other information relative to the subscriber account. The system can include a customer service center 18 which acts as an interface with the subscriber. The customer service center 18 can be comprised of human operators, and/or can be automated using voice prompts and entries from subscribers by alpha numeric keypad data entry from the telephone, or by suitable speech recognition software. A telephone premium services system 22 provides the telephone premium services to and for subscribers.

The system of the invention works in conjunction with a telecommunications system such as the publicly switched telephone network 30. The invention also has utility with wireless telecommunications systems, the Internet, and other telecommunication systems.

The subscriber 34 can utilize the invention by establishing a prepaid subscriber account. This can be accomplished by calling the customer service system 22 directly and purchasing credit with an appropriate credit instrument such as a valid credit card number. In another aspect, the account is established by the purchase of prepaid credit at a third party retailer. The credit can be purchased in the form of a calling card 40 bearing access information 44. The access information 44 can be in any suitable form, but preferably is in the form of alpha numeric indicia such as can be provided to the system 10 through the telephone system 30 by keypad or speech recognition data entry. An access telephone number is provided to the subscriber 34, and can be printed on the card 40. The access telephone number can be used to establish a telephone connection 48 with the customer service system 18 for purposes of providing the access information to the customer service system 18.

Upon reception of the access information indicia, the customer service system 18 provides this indicia to the data processing system 14 which processes this information and creates a record of the subscriber account, the credit amount, and other suitable information and stores such in memory 16. Thereafter, the account is established. The subscriber 34 is provided with a personal identification number (PIN). The PIN can be assigned by the customer service system 18, can be provided on the card 40 at the point of purchase, or can be selected by the subscriber 34 upon establishment of the account. The system can be configured such that the PIN number can be changed by the subscriber if desired. The PIN number permits the subscriber to be identified such that only the subscriber can utilize the account. Other identification data, including voice recognition and identification, code words, passwords and the like, can be used as an alternative to the PIN number.

Upon the establishment of the account, the subscriber 34 can utilize the system 10 on a prepaid basis for premium telephone services that are provided by the premium telephone services system 22. The access telephone number can be used to establish a telephone connection 42 with the premium telephone service system 22. The premium telephone services system 22 performs these services according to known technology. The premium telephone services can be performed directly by the premium telephone service system 22 or can communicate with third party providers for the provision of all or a part of the premium telephone services.

Voice mail messaging is accomplished by establishing a voice mailbox. This function can be initiated by the customer service system 18 providing suitable instructions to the premium service system 22. The voice message system can be any suitable system, and such systems are currently well known in the art. The subscriber 34 is assigned a mailbox number for voice mail messages. A caller 50 can leave messages by placing a call to a voice mail messaging telephone number which establishes a telephone connection illustrated by arrow 42. This voice mail messaging telephone number can be the access telephone number provided to the subscriber or any other suitable number for accessing the premium service system 22. The caller 50 enters the mailbox number of the subscriber 34 and is permitted to leave a voice mail message in the appropriate voice mailbox as maintained by the premium service system 22. The caller 50 can be instructed in the operation of the voice messaging system through appropriate prompts that are presented by the premium service system 22. The system 10 can be configured such that the subscriber 34 obtains the voice mail messages through the access telephone number connection 42 or through some other number. The subscriber 34 identifies the mailbox number and the subscriber's PIN or other identifying indicia in order to obtain voice mail messages.

The subscriber 34 may wish to return telephone calls from callers that have left messages in the voice mailbox of the subscriber 34. In an aspect of the invention, the premium service system 22 permits the subscriber 34 to return the telephone call through the premium service system 22 and without having to redial the access number or another telephone number to reenter the system 10, or reenter the PIN or other identification of the subscriber 34. For example, the subscriber can press a button indicating a desire to make a call, which will exit the subscriber 34 from the voicemail system 22, and then dial the desired number. In another aspect, the telephone number of callers to the voice mailbox can be recognized by standard caller identification systems. These telephone numbers can be stored in the memory 16 by the data processing system 14. The subscriber 34, upon or while listening to a voice mail message, can decide to return the call and press a button or buttons on the telephone keypad to indicate this desire. The system can retrieve from memory 16 the telephone number of the caller and dial this number for the subscriber 34 such that the subscriber can readily return the telephone call without dialing the caller's number. The account of the subscriber 34 will be debited for the connect time to the voice mail message system, as well as the connect time during the return call. Various surcharges and additional charges can be debited from the subscriber account according to the pricing structure of the system.

Although the customer service system 18, premium service system 22, data processing system 14, and memory 16 are depicted in FIG. 1 as a single unit, it will be understood that such systems can be provided separately as part of modular systems, or as an integrated system. Further, more than one data processor and memory storage device can be utilized, although a single data processing system 14 and memory 16 have been depicted for convenience.

The system of the invention can also be utilized for other premium services such as conference calling. The subscriber 34 arranges for the conference call by taking suitable step such as those currently used for conference calling. The premium telephone service system 22 can provide the conference calling capability. This can be in the form of a conference call number and access number to reach the particular conference call, as is currently known in the art. Other conference calling systems are possible. The data processing system 14 debits the prepaid account of the subscriber 34 for the conference call service.

The system of the invention can also be used for group messaging. The message is forwarded from the subscriber 34 to the designated group through the premium service system 22 to one or more recipients as indicated by recipients 58, 60 and 62. The prepaid account of the subscriber 34 is debited by the data processing system 14 according to the particular rate structure that is desired for group messaging.

The system also has utility for call forwarding. The subscriber 34 arranges to have calls to a particular mailbox in the premium telephone service system 22 forwarded to a number identified by the subscriber 34. The prepaid account of the subscriber 34 is debited by the data processing system 14.

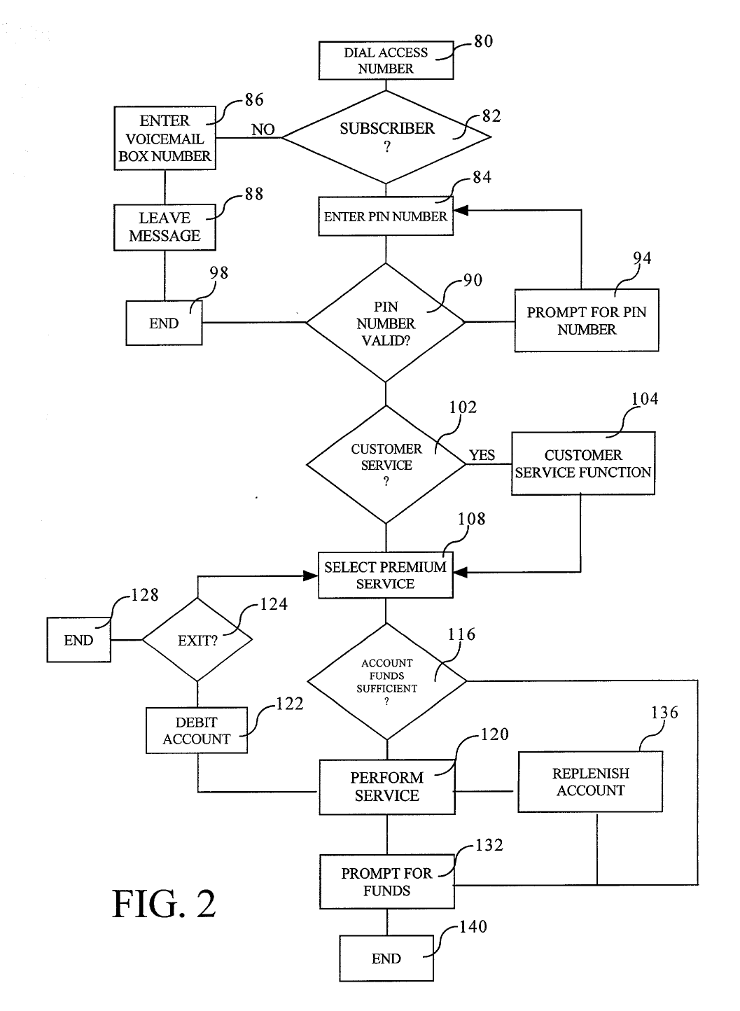

A method according to the invention is shown in FIG. 2. The method can begin in a step 80 on whoch the subscriber or a third party dials an access number. In step 82, it is determined whether the caller is a subscriber or a third party who wishes to leave a voice mail message. If the caller is a third party, then the system can prompt the caller to enter a voicemail box number. Once the voicemail box number is entered, the third party can then leave a message, as shown in step 88, and the call can end at step 98.

Referring back to step 82, if the caller is a subscriber, then in step 84, the subscriber enters access information such as a PIN number. In step 90, it is determined whether the access information is valid. If not, the system prompts for correct access information in step 94. If incorrect access information is repeatedly provided, the system disconnects in step 98. If valid access number is provided, the system can query for whether this is a call for customer service in step 102. If so, the subscriber is passed to the customer service system in step 104. If customer service is not requested or if the customer service has been completed, the subscriber can request a premium service in step 108. The system queries in step 116 as to whether the account funds are sufficient. If the funds are sufficient, the system performs the service in step 120. The subscriber account is debited for this service in step 122.

In step 124 it is determined whether the subscriber wishes to exit the system and, if so, the subscriber is disconnected in step 128. If more services are required, the method returns to step 108 for the selection of premium services. If account funds are not sufficient, the subscriber is prompted for more funds in step 132. The subscriber can replenish the account in step 136. If the account is not replenished, services are discontinued in step 140. The system can retain the account number for the subscriber for a given period of time, such as sixty days, in order to afford the subscriber time to replenish the account without changing the mailbox number and other account numbers.

The invention is capable of taking other forms without departing from the spirit or essential attributes thereof, and accordingly, reference should be had to the following claims, rather than to the foregoing specification, as indicated in the scope of the invention.

We claim:

1. A method for providing telecommunications services, comprising the steps of:
establishing a pre-paid telephone account for a subscriber;
providing an access telephone number;
receiving access information from a caller to said access telephone number;
validating said access information;
determining the sufficiency of funds in said account for a requested premium service;
providing at least one premium telephone service; and,
debiting said pre-paid account for said service.

2. The method of claim 1, wherein said premium service is at least one selected from the group consisting of voice mail messaging, and group messaging.

3. The method of claim 1, wherein said premium service is voice mail messaging, and further comprising the steps of providing a voice mail messaging telephone number for callers to said subscriber to leave voice mail messages for said subscriber and, upon validation of said access information, permitting said subscriber to access said voice mail messages.

4. The method of claim 3, further comprising the steps of providing a mailbox number for said subscriber, prompting callers for said subscriber to said voice mail messaging number for said mailbox number, and connecting said callers to a voice mailbox identified by said mailbox number.

5. The method of claim 3, wherein said account is debited pursuant to connect time of at least one of said callers leaving said messages and said subscriber retrieving said messages.

6. The method of claim 5, wherein said mail box number is retained for said subscriber so long as said account is maintained at a predetermined credit balance.

7. The method of claim 1, wherein said step of establishing a pre-paid telephone account comprises the purchase oil a card by said subscriber, said card bearing indicia for establishing said account.

8. The method of claim 7, wherein said indicia comprises a personal identification number, said method further comprising the step of receiving said personal identification number from said subscriber and, upon validation of said personal identification number, establishing said account.

9. The method of claim 7, wherein said indicia is hidden from view on said card by removable masking, said subscriber upon purchasing said card removing said masking to view said indicia.

10. The method of claim 1, further comprising the step of crediting said account upon the receipt of credit information for said subscriber.

11. The method of claim 10, wherein said credit information is provided to said subscriber upon the purchase of said credit from a third party.

12. The method of claim 11, wherein said credit information is provided on a card that is purchased from said third party, said card bearing indicia of said credit, and further comprising the step of crediting said account in an amount indicated by said credit information.

13. The method of claim 1, further comprising the step of providing a telephone calling service for said subscriber, and debiting said account for telephone calls.

14. The method of claim 1, wherein said premium service is group messaging, and said account is debited for group messaging.

15. The method of claim 1, further comprising the step of providing a customer service number, and receiving calls from said subscriber at said customer service number to establish and maintain said account

16. A system for providing premium telephone services, comprising:
a data processing system for establishing and maintaining a pre-paid subscriber account;
a premium telephone service system for providing premium telephone services for a subscriber, said data processing system determining the sufficiency of funds for a requested service and debiting said pre-paid subscriber account responsive to the provision of said premium telephone services to said subscriber.

17. The system of claim 16, wherein said premium services comprises at least one selected from the group consisting of voice mail messaging, and group messaging.

18. The system of claim 16, wherein said premium service is voice mail messaging, and further comprising a voice mail messaging telephone number for callers to said subscriber to leave voice mail messages for said subscriber.

19. The system of claim 18, wherein said data processing system validates said access information and, upon validation of said access information, permits said subscriber to access said voice mail messages.

20. The system of claim 19, further comprising a mailbox number for said subscriber, a prompter for prompting callers for said subscriber to said voice mail messaging number for said mailbox number, and a switching system for connecting said callers to a voice mailbox identified by said mailbox number.

21. The system of claim 19, wherein said data processing system debits said account pursuant to connect time of at least one of said callers leaving said messages and said subscriber retrieving said messages.

22. The system of claim 20, wherein said data processing system retains said mailbox number for said subscriber so long as said account is maintained at a predetermined credit balance.

23. The system of claim 16, further comprising a card for purchase by said subscribe, said card bearing indicia for establishing said account.

24. The system of claim 23, wherein said Indicia comprises a personal identification number, said data processing system receiving said personal identification number from said subscriber and, upon validation of said personal identification number, establishing said account.

25. The system of claim 23, wherein said indicia is hidden from view on said card by removable masking, whereby said subscriber upon purchasing said card removing said masking to view said indicia.

26. The system of claim 16, wherein said data processing system credits said account upon the receipt of credit information for said subscriber.

27. The system of claim 26, wherein said data processing system comprises a crediting system for crediting said account upon the purchase of said credit from a third party.

28. The system of claim 27, wherein said data processing system credits said account in an amount identified by said credit information.

29. The system of claim 16, further comprising a telephone calling service for said subscriber, said data processing system debiting said account based upon said telephone calls.

30. The system of claim 16, further comprising a group messaging system, said data processing system debiting said account for group messaging

31. The system of claim 16, further comprising a customer service number, said system receiving calls from said subscriber at said customer service number to establish and maintain said account.
